(19) United States
(12) Patent Application Publication
(10) Pub. No.: US 2013/0097999 A1
(43) Pub. Date: Apr. 25, 2013

(54) METHOD FOR HEATING A CATALYTIC CONVERTER IN AN ENGINE SYSTEM AND FOR DIAGNOSING THE EFFECTIVENESS OF MEASURES FOR HEATING THE CATALYTIC CONVERTER

(71) Applicants: Damien Bouvier, Stuttgart (DE); Joerg Linke, Dresden (DE)

(72) Inventors: Damien Bouvier, Stuttgart (DE); Joerg Linke, Dresden (DE)

(21) Appl. No.: 13/639,434

(22) PCT Filed: Dec. 3, 2010
(86) PCT No.: PCT/EP11/68856

§ 371 Date: Dec. 21, 2012

(30) Foreign Application Priority Data
Nov. 3, 2010 (EP) 10189748.6
Nov. 3, 2010 (EP) 10189749.8

(51) Int. Cl. F02C 9/00

(52) U.S. Cl. CPC F02C 9/00
USPC 60/273; 60/320

(57) ABSTRACT

A method for operating an internal combustion engine in a catalytic converter heating operation, the internal combustion engine being able to be operated in a normal operation, including the following steps: ascertaining a first exhaust gas temperature reading, which gives the exhaust gas temperature of the exhaust gas in a first catalytic converter, particularly in an oxidation catalytic converter; operating the internal combustion engine in a first operating mode, in which, in contrast to the normal operation, the exhaust gas, having an increased exhaust gas temperature, is exhausted from at least one cylinder of the internal combustion engine, as long as the first exhaust gas temperature reading has not reached a specified first temperature threshold value. This method enables a robust and simple diagnosis of the effectiveness of the catalytic converter heating operation according to the requirements of CARE Title 13 CCR Section 1968.2 Chapter.

### FIELD OF THE INVENTION

The present invention relates to an engine system having internal combustion engines, particularly using Diesel engines, in whose exhaust gas sections an oxidation catalytic converter and a reduction catalytic converter are situated in series. The present invention also relates to a method for operating the engine system for a heating phase, in order to bring the catalytic converters to an operating temperature.

### BACKGROUND INFORMATION

Today's engine systems having internal combustion engines, particularly having Diesel engines, have catalytic converters in the exhaust-gas system, in order to reduce harmful emissions. In modern engine systems, a so-called oxidation catalytic converter (Oxi-Kat, in German, in brief) and a postconnected reduction catalytic converter are usually used in the form of an SCR catalytic converter (SCR: selective catalytic reduction). In addition, the SCR catalytic converter requires the introduction of reducing agents into the exhaust-gas system, for instance, in the form of urea.

Since the catalytic converters require a certain operating temperature for proper operation, after a cold start of the engine system, the internal combustion engine is usually operated according to a catalytic converter heating operation, in which first the oxidation catalytic converter and then the reduction catalytic converter are brought to their operating temperatures. Because of the heating operation, the operating temperatures of the catalytic converters (light-off temperature) is reached earlier, which is necessary for the fulfillment of legally prescribed exhaust gas norms.

Up to now, methods for the heating operation of the SCR catalytic converter have provided a controller by which the heating up of the SCR catalytic converter is controlled over time. This is done by a specification fixed over time for operating the internal combustion engine, having the aim of increasing the temperature in the SCR catalytic converter. Because of this, however, system variations or the effects of operating parameters, such as environmental temperature, fuel quality and the like cannot be taken into account. As a result, the effectiveness of the heating process, and thus the temperature increase aimed at in the SCR catalytic converter may have very great variations.

Furthermore, monitoring the heating process is required. Up to now, the individual components, that take part in the heating process, have been monitored for their functioning capability, in order that the desired heating effect will really be achieved. But this is costly to implement.

It is therefore an object of the present invention to provide an improved method for heating up a catalytic converter in an engine system, in which particularly the effects of operating parameters and system variations are taken into account, so that a specified operating temperature is able to be reached as quickly as possible. In addition, it is an object of the present invention to enable making a diagnosis for monitoring the effectiveness of heating of the catalytic converter.

### SUMMARY

According to one first aspect of an example embodiment of the present invention, a method is provided for operating an internal combustion engine in a catalytic converter heating operation, the internal combustion engine being operable in a normal operation. The method includes the following steps:
ascertaining a first exhaust gas temperature reading, which gives the exhaust gas temperature of the exhaust gas in a first catalytic converter, particularly in an oxidation catalytic converter;
operating the internal combustion engine in a first operating mode, in which, in contrast to normal operation, exhaust gas having an increased temperature is exhausted from at least one cylinder of the internal combustion engine, as long as the first exhaust gas temperature reading has not reached a first temperature threshold value.

In accordance with the above example method, the heating process is basically carried out for the first catalytic converter as a function of the first exhaust gas temperatures reading on the exhaust gas temperature of the first catalytic converter, in order to reach the operating temperature of the catalytic converter as rapidly as possible. In this context, component part tolerances and other influences are taken into account, since the respectively current exhaust gas temperature is detected, and the heating process is undertaken until the operating temperature, which is able to be given by the first temperature threshold value, has been reached.

Moreover, in the first operating mode, additional fuel may be injected into the at least one cylinder, before or during the combustion process, when there is an excess of air, in order to implement a so-called early postinjection.

In the first operating mode, the internal combustion engine may particularly be operated so that no uncombusted fuel gets into the exhaust gas removal section.

According to one specific embodiment, in the first operating mode, the first exhaust gas temperature reading may be regulated to a specified first setpoint temperature, the regulating intervention only relating to internal engine measures, in particular, the regulating intervention including the apportionment of an additional heating fuel quantity between a main injection and preinjections and/or postinjections.

Furthermore, the specified first setpoint operating temperature may be varied as a function of an operating state of the engine system, so that the difference between the first exhaust gas temperature reading and the specified first setpoint operating temperature does not exceed a specified boundary value.

According to an additional specific embodiment, when the specified first temperature threshold value is reached, the following steps are carried out:
ascertaining a second exhaust gas temperature reading, which gives the exhaust gas temperatures in a second catalytic converter, which is postconnected to the first catalytic converter.
operating the internal combustion engine in a second operating mode, in which the exhaust gas exhausted from the cylinders of the internal combustion engine contains uncombusted fuel, which combusts in the exhaust gas removal section for increasing the exhaust gas temperature and/or oxidizes in the first catalytic converter, so that, because of this, the exhaust gas temperatures is increased as long as the second exhaust gas temperature reading has not reached a specified second setpoint operating temperature for the second catalytic converter.

It may be provided that, in the second operating mode, the exhaust gas temperature of the exhaust gas in the second catalytic converter is regulated to the specified second setpoint operating temperature, the regulating intervention relating to a late post-injection of fuel after a combustion process in the at least one cylinder.

According to one further aspect, a method for monitoring the functioning of the catalytic converter heating operation may be provided, in which an error in the functioning of the catalytic converter heating operation is detected if, during the regulations, the difference between the first exhaust gas temperature reading and the specified first setpoint operating temperature or the difference between the second exhaust gas temperature reading and the specified second setpoint operating temperature exceeds a specified diagnostic boundary value during a specified time period.

One idea of the above diagnostic method is to evaluate the system deviation and to detect an error if the system deviation is exceeded for a specified maximum duration.

According to one further aspect, a device may be provided for operating an internal combustion engine in a catalytic converter heating operation, the internal combustion engine being operable in a normal operation. The device may include:
a first temperature sensor for ascertaining a first exhaust gas temperature reading, which gives the exhaust gas temperature of the exhaust gas in a first catalytic converter;
a control unit that is developed for operating the internal combustion engine in a first operating mode, in which, in contrast to normal operation, exhaust gas having an increased temperature is exhausted from at least one cylinder of the internal combustion engine, as long as the first exhaust gas temperature reading has not reached a specified first temperature threshold value.

According to a further aspect, an engine system may be provided having an internal combustion engine and the above device, the internal combustion engine being developed to exhaust exhaust gas into an exhaust gas removal section, the first temperature sensor being situated between the internal combustion engine and the first catalytic converter.

Furthermore, the above device may have a second temperature sensor for ascertaining a second exhaust gas temperature reading which gives an exhaust gas temperature of the exhaust gas in a second catalytic converter, which is postconnected to the first catalytic converter and may include the control unit that is developed, when the specified first temperature threshold value has been reached, to operate the internal combustion engine in a second operating mode, in which the exhaust gases exhausted from the cylinders of the internal combustion engine contains uncombusted fuel, which is combusted to increase the exhaust gas temperature in the exhaust gas removal section and/or oxidizes in the first catalytic converter, so that the exhaust gas temperature is thereby increased as long as the second exhaust gas temperatures reading has not reached a specified second setpoint operating temperature.

According to a further aspect, an engine system may be provided with an internal combustion engine and the abovementioned device, the second temperature sensor being situated between the first catalytic converter and the second catalytic converter.

According to another aspect, a computer program product is provided, which includes a program code that implements the above method when it is executed on a data processing device.

### BRIEF DESCRIPTION OF THE DRAWINGS

Preferred specific embodiments are explained in greater detail below on the basis of the figures.

FIG. 1 shows a schematic representation of an engine system having an oxidation catalytic converter and a postconnected reduction catalytic converter.

FIG. 2 shows a flow chart for depicting a method for a heating process for heating up the catalytic converters to their operating temperatures.

### DETAILED DESCRIPTION OF EXAMPLE EMBODIMENTS

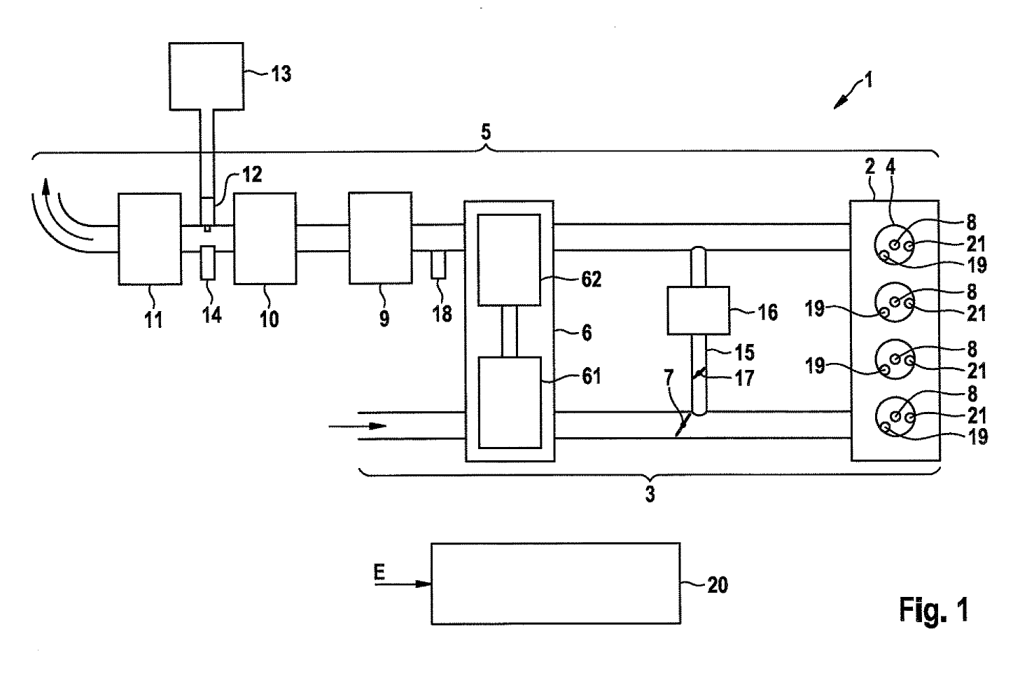

FIG. 1 shows a schematic representation of an exemplary engine system 1 having an internal combustion engine 2, particularly a Diesel engine. Environmental air is conveyed to internal combustion engine 2 via an air supply section 3, and combustion waste gases are removed from cylinders 4 of internal combustion engine 2 via an exhaust gas removal section 5 into the environment. In the present example, internal combustion engine 2 includes four cylinders 4, in which, in each case, an injector 8 is situated for the direct injection of fuel. Air is admitted into cylinders 4 via appropriate intake valves 19, and is ejected via outlet valves 21 into exhaust gas removal section 5.

A turbocharger 6 is situated in air supply section 3 and in exhaust gas supply section 5, and it has a compressor 61 and a turbine 62.

Turbine 62 is situated in exhaust gas supply section 5 and takes drive energy for compressor 61 from the exhaust gas enthalpy. Turbine 62 is connected to compressor 61, in order to drive it. Compressor 61 aspirates air from the environment and provides it under a charge air pressure. The air provided under the charge air pressure, the so-called charge air, is supplied to internal combustion engine 2 via a throttle valve 7. There, the air is let, via appropriate intake valves 19, into cylinders 4, in correspondence with the power cycle.

Downstream from turbine 62, there is an oxidation catalytic converter 9, which is used for the exhaust gas aftertreatment. The pollutant emissions in the exhaust gas are drastically reduced by oxidation catalytic converter 9. In particular, carbon monoxide and nitrogen oxides are oxidized to less harmful gases.

After that, the exhaust gas stream is able to be conveyed through an optional particulate filter 10 in order to reduce the particles present in the exhaust gas of Diesel engines, particularly soot particles, that are created in Diesel engines.

After particulate filter 10, the filtered exhaust gases are conveyed to a subsequently situated reduction catalytic converter 11, which may be developed, for instance, as an SCR catalytic converter (SCR: selective catalytic reduction). In the case of the SCR catalytic converter, an aqueous urea solution is continuously injected as a reducing agent into the exhaust gas flow, so that water and ammonia are produced by hydrolysis. Ammonia is in a position to reduce the nitrogen oxides in the exhaust gas to nitrogen.

Between particulate filter 10 and SCR catalytic converter 11, a metering module 12 is situated at an appropriate part of exhaust gas removal section 5, in order to add the reducing agent from a reducing agent container 13 to the exhaust gas at suitable metering, so that reduction of nitrogen oxides takes place in SCR catalytic converter 11.

Upstream of oxidation catalytic converter 9, a first temperature sensor 18 is provided, in order to measure a first exhaust gas temperature at the input of oxidation catalytic converter 9 as state variable. In the part of the exhaust gas removal section between particulate filter 10 and SCR catalytic converter 11, a second temperature sensor 14 is provided, in order to measure a second exhaust gas temperature of the exhaust gas at the output of oxidation catalytic converter 9 and before entry into SCR catalytic converter 11, as a state variable.

Between internal combustion engine 2 and turbine 62 of supercharger 6, an exhaust gas recirculation line 15 is provided, in order to recirculate combustion waste gases from exhaust gas removal section 5 into the region of air supply section 3, between throttle valve 7 and intake valves 19 of internal combustion engine 2. The recirculated exhaust gas is used as inert gas, and does not take part in the combustions in the combustion chambers of cylinders 4. It is, however, used to avoid excessive creation of nitrogen oxides, which frequently occurs during combustion involving excess oxygen.

In exhaust gas recirculating line 15, an exhaust gas cooler 16 and an exhaust gas recirculating valve 17 may be provided, in order to be able to set the quantity of the recirculated exhaust gas and the rate of exhaust gas recirculation coming about from this.

A control unit 20 is provided for operating the internal combustion engine, which actuates internal combustion engine 2 based on a specification variable E, such as a reading of an accelerator pedal position, a desired drive torque and the like, as well as, based on state variables recorded in engine system 1, actuates actuators of engine system 1 in order to operate internal combustion engine 2 according to the specification variable. The actuators of engine system 1 may include, for instance, the throttle actuator for setting throttle valve 7, via which the intake manifold pressure and the air quantity supplied to the cylinders may be set, supercharger 6 by which the charge air pressure is able to be set (for instance, via setting the efficiency by adjusting the turbine geometry), exhaust gas recirculating valve 17, by which the rate of exhaust gas recirculation is able to be set, injection valves 8 in cylinders 4 for setting the fuel quantity and the injection times.

Oxidation catalytic converter 9 and reduction catalytic converter 11, for orderly operation, have to be heated up to an operating temperature. After a cold start of engine system 1, therefore, a so-called heating-up operation is provided, by which heating up both oxidation catalytic converter 9 and reduction catalytic converter 11 may be carried out in a speeded-up manner.

During the heating-up process, the aim is first of all to reach the operating temperature of oxidation catalytic converter 9. This may be done with the aid of a first control loop which, via internal engine measures, increases the operating temperature of oxidation catalytic converter 9, in order to put oxidation catalytic converter 9 in a position to oxidize hydrocarbons. To do this, a setpoint operating temperature for oxidation catalytic converter 9 is specified, which represents a setpoint value for the first control loop. With the aid of first temperature sensor 18, a first exhaust gas temperature of the exhaust gas before oxidation catalytic converter 9 is measured, and is selected depending on the amount of the system deviation, i.e., depending on the amount of the temperature difference between the specified setpoint operating temperature of oxidation catalytic converter 9 and the operating temperature 18. In the case of a large positive system deviation, i.e., a system deviation above a specified threshold value, the first control loop is supposed to vary the injection durations and the injection points as a function of the behavior of oxidation catalytic converter 9.

Possibilities of the variation of injection quantities and injection times for heating up oxidation catalytic converter 9 consist of injecting fuel into cylinder 4 as an early afterinjection, after or during combustion. The fuel thus injected combusts generally after the power stroke in the cylinder, or in the immediately following range of the exhaust gas removal section, and has an effect only in an increase of the exhaust gas temperature, without contributing to the drive torque of internal combustion engine 2.

An additional possibility of increasing the exhaust gas temperatures is to add more fuel during the main injection and in the case of possible preinjections taking place before the main injection.

In the case of a so-called afterinjection, the fuel is injected into the cylinder so late that it does not burn in the cylinder any more but, uncombusted, reaches oxidation catalytic converter 9, and reacts there with air oxygen. This oxidation gives off heat.

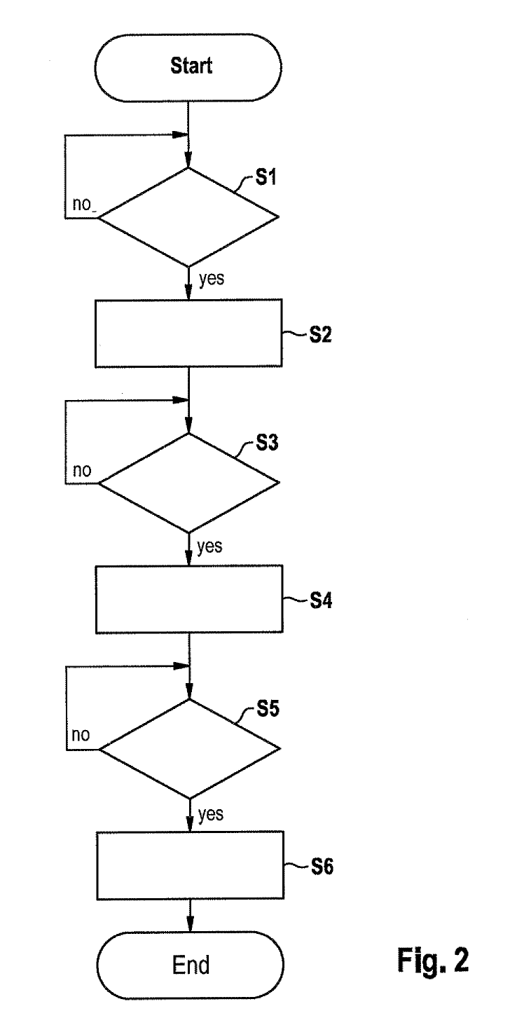

FIG. 2 shows the example method for heating the catalytic converters as a flow chart.

In step S1 it is checked, with the aid of first temperature sensor 18, whether a heating-up operation has to be performed. A heating-up operation is required if it is determined that the exhaust gases flowing into oxidation catalytic converter 9 are cooler than given by a specified first temperature threshold value. If the heating-up operation is necessary (alternative: yes), in step S2 internal combustion engine 2 is operated according to a first type of heating-up operation. For this, the first control loop in control unit 20 is activated to which the setpoint operating temperature of oxidation catalytic converter 9 is specified as setpoint value. This setpoint operating temperature is initialized using the current actual temperature at the start of the heating-up operation, and is updated as a function of the engine operating point and the duration of the type heating-up operation, and increased continuously or step-wise up to a first temperature threshold value. The first control loop controls internal combustion engine 2 in such a way that the exhaust gas temperature of the exhaust gas exhausted from cylinders 4 is higher than in normal operation, so that oxidation catalytic converter 9 is able to heat up.

While the first control loop is active, the first exhaust gas temperature is monitored in step 93, and as soon as the first temperature threshold value is exceeded by the first exhaust gas temperature (alternative: yes), in step 94, the second type of heating-up operation is assumed, in which exclusively or supplementarily heating SCR catalytic converter 11 is undertaken. In the second type of heating-up operation, therefore, the second control loop is activated alternatively or additionally to the first control loop. As a function of the difference between the second exhaust gas temperature and a specified second setpoint operating temperature, which may be equivalent to a working temperature of SCR catalytic converter 11, the second control loop, by undertaking an afterinjection, controls the quantity of uncombusted fuel that reaches exhaust gas removal section 5 and oxidation catalytic converter 9. This second setpoint operating temperature is initialized using the current actual temperature at the start of the heating-up operation, and is updated as a function of engine operating point 8 and of the duration of the type of heating-up operation, and is increased continuously or step-wise up to a second temperature threshold value.

In step S5, it is checked whether the specified second setpoint operating temperature has been reached. If this is the case (alternative: yes), in step 96, the internal combustion engine is operated in a normal operating manner, and the heating-up operation is ended (step S6).

It may further be provided that, if the system deviation of the first control loop is greater than a specified system deviation threshold value, internal combustion engine 2 is operated exclusively in the first type of heating-up operation, which corresponds to a lean operation having an early afterinjection of additional fuel. Because of that, a combustion exhaust gas having a higher exhaust gas temperature is exhausted from cylinders 4, whereby oxidation catalytic converter 9 is heated faster than is the case in a normal operation.

If the temperature difference between the first exhaust gas temperature measured, using first temperature sensor 18, and the specified first setpoint operating temperature drops below the system deviation threshold value, the fuel quantity provided for heating is rapidly injected according to a late afterinjection, so that the combustion of the fuel takes place in the outlet region or the oxidation takes place in oxidation catalytic converter 9, and consequently heat is produced there directly.

However, at too great a temperature difference, that is, at too great a system deviation, the fuel quantity, that is injected as a late afterinjection, should not be too greatly increased, since then there is the danger that the fuel does not combust completely in oxidation catalytic converter 9, and hydrocarbons reach subsequent SCR catalytic converter 11, so that the latter is “poisoned” thereby. The hydrocarbons may, in particular, block the functioning of the SCR catalytic converter, and make necessary frequent regeneration of the SCR catalytic converter, which considerably reduces the efficiency of the engine system.

This behavior may be avoided by having the control intervention of the first control loop relate exclusively to internal engine measures, and not admit any late afterinjection. It may especially be provided that the apportionment of an additional heating-up fuel quantity between a main injection and preinjections is the main manipulated variable of the first control loop.

The monitoring of the system deviation between the first exhaust gas temperature and the first setpoint operating temperature may be used as a diagnosis. In particular, it may be used for checking the effect of the measures connected to the first type of heating-up operation.

If the first temperature threshold value is reached concerning oxidation catalytic converter 9, then according to the second type of heating-up operation of the heating-up process, reduction catalytic converter 11 is heated up. To this end, the second exhaust gas temperature of the exhaust gas before SCR catalytic converter 11 is measured by second temperature sensor 14. As a function of a temperature difference between the specified second setpoint operating temperature of SCR catalytic converter 11 and the second exhaust gas temperature of the exhaust gas before SCR catalytic converter 11, the regulation of the second control loop is carried out.

As the main manipulated variable of the second control loop, an injection of fuel after combustion in the cylinders is now carried out as a late afterinjection. Because of this, the fuel combusts in the outlet range of cylinders 4 or first in oxidation catalytic converter 9, and heats the exhaust gas exhausted from cylinders 4 in such a way that SCR catalytic converter 11 is heated up.

Both in the first and also in the second regulation it may be provided that the specified setpoint operating temperatures of the exhaust gas be determined as a function of the operating point of internal combustion engine 2, which are determined by the rotational speed, the injection quantity, the rate of exhaust gas recirculation, the traveling speed, the environmental conditions, such as the environmental temperature and the environmental air pressure, as well as the time during which the heating-up operation is active. In particular, the setpoint operating temperatures may be moderately adjusted to the instantaneous operating state in such a way that it is avoided that the system deviation becomes too large. A large system deviation would have the result that a large fuel quantity would be additionally injected into cylinders 4 of the internal combustion engine. At too low a first exhaust gas temperature before oxidation catalytic converter 9 or in oxidation catalytic converter 9, this leads to the uncombusted fuel in oxidation catalytic converter 9 not being combusted, and, because of that, fuel gets into SCR catalytic converter 11. The poisoning of SCR catalytic converter 11 by hydrocarbons would be the result.

Furthermore, a method for monitoring the effectiveness of the heating-up process may be carried out, and for this the diagnosis is released when the regulations have exhausted all the setting possibilities, that is, when the manipulated variables, such as the injection quantity that is injected in the late afterinjection, has a maximum value, and the general release conditions, which depend on the rotational speed, the injection quantity and the like, have remained steady for a certain time. An error is detected if the system deviation in one of the regulations exceeds a specified threshold value for a certain time period.

1-13. (canceled)

14. A method for operating an internal combustion engine in a catalytic converter heating operation, the internal combustion engine being able to be operated in a normal operation, the method comprising:
ascertaining a first exhaust gas temperature reading which gives an exhaust gas temperature of exhaust gas in a first catalytic converter; and
operating the internal combustion engine in a first operating mode, in which, in contrast to normal operation, exhaust gas, having an increased exhaust gas temperature, is exhausted from at least one cylinder of the internal combustion engine, as long as the first exhaust gas temperature reading has not reached a specified first temperature threshold value.

15. The method as recited in claim 14, wherein the first catalytic converter is an oxidation catalytic converter.

16. The method as recited in claim 14, wherein, in the first operating mode, additional fuel is injected into the at least one cylinder, one of before or during a combustion process, when there is an excess of air.

17. The method as recited in claim 14, wherein, in the first operating mode, the internal combustion engine is operated so that no uncombusted fuel gets into an exhaust gas removal section.

18. The method as recited in claim 14, wherein, in the first operating mode, the first exhaust gas temperature reading is regulated to a specified first setpoint operating temperature, a regulating intervention only relating to internal engine measures, the regulating intervention including apportionment of an additional heating fuel quantity between a main injection and preinjections.

19. The method as recited in claim 18, wherein the specified setpoint operating temperature is varied as a function of an operating state of the engine system, so that a difference between the first exhaust gas temperature reading and the specified first setpoint operating temperature does not exceed a specified boundary value.

20. The method as recited in claim 14, wherein, when the specified first temperature threshold value is reached, performing the steps:
ascertaining a second exhaust gas temperature reading, which gives an exhaust gas temperature of exhaust gas in a second catalytic converter which is postconnected to the first catalytic converter; and
operating the internal combustion engine in a second operating mode, in which the exhaust gas exhausted from the cylinders of the internal combustion engine contains uncombusted fuel, which at least one of combusts in the exhaust gas removal section and oxidizes in the first catalytic converter so as to increase the exhaust gas temperature, so that, the exhaust gas temperature is increased as long as the second exhaust gas temperature reading has not reached a second second setpoint operating temperature for the second catalytic converter.

21. The method as recited in claim 20, wherein, in the second operating mode, the exhaust gas temperature of the exhaust gas in the second catalytic converter is regulated to the specified second setpoint operating temperature, a regulating intervention relating to a late postinjection of fuel after a combustion process in the at least one cylinder.

22. The method as recited in claim 20, further comprising:
detecting an error in a functioning of the catalytic converter heating operation if one of: i) a difference between the first exhaust gas temperature reading and the specified first setpoint operating temperature, or ii) a difference between the second exhaust gas temperature reading and the specified second setpoint operating temperature, exceeds a specified diagnostic boundary value during a specified time period.

23. A device for operating an internal combustion engine in a catalytic converter heating operation, the internal combustion engine being able to be operated in a normal operation, the device comprising:
a first temperature sensor to ascertain a first exhaust gas temperature reading, which gives an exhaust gas temperature of exhaust gas in a first catalytic converter; and
a control unit configured to operate the internal combustion engine in a first operating mode, in which, in contrast to a normal operation, exhaust gas having an increased exhaust gas temperature is exhausted from at least one cylinder of the internal combustion engine, as long as the first exhaust gas temperature reading has not reached a specified first temperature threshold value.

24. An engine system, comprising:
an internal combustion engine; and
a device including a first temperature sensor to ascertain a first exhaust gas temperature reading, which gives an exhaust gas temperature of exhaust gas in a first catalytic converter, and a control unit configured to operate the internal combustion engine in a first operating mode, in which, in contrast to a normal operation, exhaust gas having an increased exhaust gas temperature is exhausted from at least one cylinder of the internal combustion engine, as long as the first exhaust gas temperature reading has not reached a specified first temperature threshold value;
wherein the internal combustion engine is configured to exhaust exhaust gas into an exhaust gas removal section, the first temperature sensor being situated between the internal combustion engine and the first catalytic converter.

25. The engine system as recited in claim 23, wherein the device further comprises:
a second temperature sensor to ascertain a second exhaust gas temperature reading, which gives an exhaust gas temperature of the exhaust gas in a second catalytic converter, which is postconnected to the first catalytic converter;
wherein the control unit is configured to operate the internal combustion engine in a second operating mode when the specified first temperature threshold value has been reached, the second mode being a mode in which the exhaust gas exhausted from the cylinders of the internal combustion engine contains uncombusted fuel, which at least one of combusts in the exhaust gas removal section, and oxidizes in the first catalytic converter so as to increase the exhaust gas temperature, so that the exhaust gas temperatures is increased as long as the second exhaust gas temperature reading has not reached a specified second setpoint operating temperature.

26. The engine system as recited in claim 25, wherein the second temperature sensor is situated between the first catalytic converter and the second catalytic converter.

27. A storage device storing a computer program including a program code for operating an internal combustion engine in a catalytic converter heating operation, the internal combustion engine being able to be operated in a normal operation, the program code, when executed by a data processing unit, causing the data processing unit to perform the steps of:
ascertaining a first exhaust gas temperature reading, which gives an exhaust gas temperature of exhaust gas in a first catalytic converter; and
operating the internal combustion engine in a first operating mode, in which, in contrast to normal operation, exhaust gas, having an increased exhaust gas temperature, is exhausted from at least one cylinder of the internal combustion engine, as long as the first exhaust gas temperature reading has not reached a specified first temperature threshold value.
